(19) United States
(12) Patent Application Publication
(10) Pub. No.: US 2018/0202492 A1
(43) Pub. Date: Jul. 19, 2018

(54) SLIDING BEARING, SLIDING BEARING MATERIAL, METHOD FOR PRODUCING A SLIDING BEARING MATERIAL AND USE OF A SLIDING BEARING MATERIAL FOR A SLIDING BEARING

(71) Applicant: FEDERAL-MOGUL WIESBADEN GMBH, WIESBADEN (DE)

(72) Inventors: HOLGER SCHMITT, PFUNGSTADT (DE); DANIEL MEISTER, MAINZ (DE)

(21) Appl. No.: 15/744,406

(22) PCT Filed: Jul. 6, 2016
(86) PCT No.: PCT/EP2016/065963

§ 371 Date: Jan. 12, 2018

(30) Foreign Application Priority Data
Jul. 13, 2015 (DE) 10 2015 213 052.5

(51) Int. Cl. F16C 33/12; F16C 33/14; C22C 21/00; B22D 11/00; C22F 1/04; C22C 1/10

(52) U.S. Cl. CPC F16C 33/125; F16C 33/121; F16C 33/14; C22C 21/003; B22D 11/003; F16C 2206/00; C22F 1/04; C22C 1/1036; F16C 2204/20; F16C 2204/60; B22D 11/005

(57) ABSTRACT

The present application relates to a sliding bearing material comprising a steel substrate back and an aluminum alloy applied thereto, characterized in that the aluminum alloy contains an aluminum alloy matrix and hard particles, preferably 0.01 to 10 wt %, and/or fibers, preferably 0.01 to 50 vol %. The invention further relates to a method for producing a sliding bearing material, to the use of a sliding bearing material for a sliding bearing and to a sliding bearing.

### TECHNICAL FIELD

The present invention relates to a sliding bearing or a part thereof, a sliding bearing material, a method for producing the same and to the use of a sliding bearing material for a sliding bearing. A sliding bearing according to the invention is characterized by high thermal conductivity, good mechanical properties, improved sliding properties and good workability.

### PRIOR ART

The use of aluminum alloys as sliding bearing material is known from the prior art.

In addition, DE 10 2011 004 133 A1 describes a method for producing a sliding bearing, in which an aluminum-iron-silicon alloy is rolled onto a steel back, and a sliding bearing having a sliding surface of an aluminum-iron-silicon alloy.

### OUTLINE OF THE INVENTION

The object of the invention is to provide a sliding bearing that has the simplest possible chemical composition and easy manufacturability, while at the same time exhibiting improved sliding properties and mechanical properties.

This object is achieved by the sliding bearing described in claim 6, the sliding bearing material described in claim 1, the method for producing the sliding bearing material according to claim 7 and the use of a sliding bearing material for a sliding bearing according to claim 5.

The combination of a steel substrate back and an aluminum alloy containing hard particles and/or fibers in addition to the aluminum alloy matrix applied thereto, gives rise to advantageous mechanical properties of the sliding bearing. Moreover, the use of a steel substrate back allows the favorable properties of the aluminum alloy to be exploited at those positions of the sliding bearing where they are required, while less critical positions can be made from cheaper material. Because the added fibers and/or hard particles, the aluminum alloy exhibits enhanced rigidity and strength. At the same time, the aluminum alloy matrix provides high thermal conductivity, of the level of that of pure aluminum, and ensures better heat dissipation under mixed friction conditions. The aluminum alloy preferably contains 0.01-50 vol % and/or 0.01 to 54 wt %, particularly preferably >10 to 50 wt % fibers and 0.01 to 10 wt % hard particles, to guarantee sufficient effect of the fibers and/or hard particles on the mechanical properties.

Preferred further developments are described in the further claims.

Preferably lubricants are added to the aluminum alloy, for example, h-BN and/or graphite, particularly preferably in a concentration of 0.01 to 10 wt %, for improving the sliding properties.

The aluminum alloy matrix additionally contains up to 3 wt % respectively Cu, Mn, Mg, Si, Fe, V, Ti, Sc, Cr, Zn and/or Ni, since this further strengthens the matrix. In addition, up to 15 wt % Sn can advantageously be added as solid lubricant, however, the strengthening effect of the fibers and hard particles is diminished at higher tin contents. Also, up to 0.2 wt %, preferably 0.02 to 0.05 wt %, Sr, boron, TiB₂ and/or Na can be added to the aluminum alloy matrix to influence the precipitation behavior and refinement of the alloy. In particular this can be used to advantageously adjust the shape and size of the precipitates. The stated alloy elements are readily available and cheap. Moreover, the moderate hardness of the alloy matrix ensures good embeddability of the hard particles.

Preferably, the hard particles are selected from the group of carbides, nitrides, borides and/or oxides, for example B₄C, TaC, ZrC, HfC, Cr₂C WC, TaN, ZrN, HfN, TiN, TaB, ZrB₂, HfB, CrB₂, Mob, WB, HfO₂, CrO₂ and/or MgO. Preferably, the hard particles consist of TiC, MoC, AIN, c-BN, TiB₂ and/or Y₂O₃, particularly preferably of SiC, Si₃N₄, ZrO₂ and/or Al₂O₃. The hard particles preferably exhibit a size <20 μm, since this provides an adequate increase in strength.

The fibers for the aluminum alloy are selected from the group of organic and/or inorganic fibers, in particular tungsten fibers, zirconium oxide fibers, boron fibers and steel fibers. Preferably the fibers are glass fibers and/or ceramic fibers, particularly preferably SiC fibers, carbon fibers and/or Al₂O₃ fibers. Furthermore, the fibers advantageously have a length <50 μm and a diameter <3 μm, particularly preferably the fibers are in the form of nanotubes, for example carbon nanotubes. The stated fibers of the specified dimensions advantageously increase the strength of the aluminum alloy.

Furthermore, a preferred embodiment of the invention provides for the fibers having a higher tensile strength and/or a higher modulus of elasticity and/or a lower fracture elongation in the longitudinal direction than the aluminum alloy matrix. Such a combination of aluminum alloy matrix and fibers gives rise to excellent mechanical properties of the overall material.

The steel substrate back consists of one of the steels C06, C10, C22 or CXX (wherein XX >22). The named steels are readily available and bond particularly well with the aluminum alloy to produce a sliding bearing material.

Moreover, according to a further embodiment, an intermediate layer is inserted between the steel substrate back and the aluminum alloy, said intermediate layer preferably consisting of an aluminum alloy of the 1xxx, 2xxx or 3xxx alloy series. The intermediate layer advantageously improves the bond between steel substrate back and aluminum alloy.

Preferably the sliding bearing material according to any of the preceding embodiments is used to produce a sliding bearing or a part thereof. This can provide a sliding bearing that has a simple chemical composition and easy manufacturability, while at the same time exhibiting improved sliding properties and mechanical properties.

The sliding bearing material according to any of the said embodiments is preferably produced by hot roll cladding or cold roll cladding the aluminum alloy onto the steel substrate back. This guarantees an excellent bond between the aluminum alloy and the steel substrate back under cost-effective and time-efficient conditions. Due to the dynamic recrystallization associated with hot roll cladding, this process achieves higher levels of deformability and thus a better bond between steel substrate and aluminum alloy.

It is advantageously further provided for an aluminum foil consisting of an aluminum alloy of the 1xxx, 2xxx or 3xxx alloy series to first be applied, preferably roll cladded, onto the steel substrate back before roll cladding of the aluminum alloy. Furthermore, the aluminum foil can also be roll cladded onto the steel substrate back together with the aluminum alloy in a single rolling step. In the case of cold roll cladding in particular, applying the aluminum foil can improve the bond between the aluminum alloy and the steel substrate.

It is particularly preferred that homogenization heat treatment and/or recrystallization heat treatment be performed in the temperature range from 200° C. 600° C. with a holding time of 1-30 h prior to roll cladding. This serves to guarantee homogenous distribution of the alloy elements, Moreover, high levels of deformability can be achieved by recrystallization heat treatment, due to the associated softening.

Furthermore, the method for producing a sliding bearing material advantageously comprises the following process steps:
Transforming the alloy elements, particles and/or fibers of the aluminum alloy into a molten pool,
Continuous casting the melt into a strand of substantially rectangular cross-section,
Heat treatment of the strand,
Roiling the strand
Heat treatment of the rolled strand and
Roll cladding of the aluminum alloy onto a steel substrate back.

By transforming the alloy elements, particles and/or fibers of the aluminum alloy into a molten pool, it is possible to guarantee sufficiently fine and homogenous distribution of the components in the aluminum alloy, Continuous casting, preferably continuous, in a rectangular cross-section advantageously simplifies the subsequent rolling and/or roll cladding steps. Heat treatment serves to advantageously adjust the microstructure and achieve the softening required for forming. Roll cladding serves to create a permanent bond between steel substrate and aluminum alloy under cost-effective and time-efficient conditions.

All of the features mentioned above and below in association with the sliding bearing material are also applicable to the method according to the invention, the novel use and the sliding bearing and vice versa.

### PREFERRED EMBODIMENT

According to a preferred embodiment, the alloy elements of the aluminum alloy matrix, namely approximately 0.05 wt % Sr, approximately 14.0 wt % Sn, approximately 1.0 wt % copper and the rest being aluminum and inevitable impurities, and approximately 5 wt % SiC hard particles and approximately 20 vol. % Al₂O₃fibers are transformed into a molten pool at a temperature of 800° C. The weight data given for the alloy elements refer to the aluminum alloy matrix. The specified percentage by volume of fibers can be converted into a corresponding percentage by weight via the known density of the fibers. At the said melting temperature, the hard particles and fibers remain in the solid phase and convection ensures fine and homogenous distribution of the hard particles and fibers in the melt The aluminum alloy is then cast into a strand of rectangular cross-section by means of continuous casting. The aluminum alloy matrix is homogenized by homogenization heat treatment at approximately 450° C. and holding time of 16 h, so that the strand can be rolled to a thickness of 1.1 mm in the subsequent rolling steps due to its reduced strength. The aluminum alloy is then applied to a C06 steel by means of hot roll cladding. Due to dynamic recrystallization during hot roll cladding, high levels of deformability and thus excellent bonding can be achieved between the steel substrate and the aluminum alloy. In order to improve adhesion between substrate and aluminum alloy, the respective surfaces are ground and brushed prior to the hot roll cladding. Ultimately, a bearing shell is made out of the sliding bearing material by means of the usual forming steps and surface finishing.

1. Sliding bearing material comprising a steel substrate back and an aluminum alloy applied thereon, wherein
the aluminum alloy contains an aluminum alloy matrix, hard particles in an amount, 0.01 to 10 wt %, fibers in an amount of, 0.01 to 50 vol % and 0.01 to 54 wt %, and the steel substrate back consists of one of the steels C06, C10, C22 or CXX (wherein XX>22), wherein,
the aluminum alloy matrix is lead-free and/or comprises one or more of the following alloy elements:
up to 3 wt % respectively of Cu, Mn, Mg, Si, Fe, V, Ti, Sc, Cr, Zn and/or Ni;
up to 15 wt % Sn;
up to 0.2 wt %, preferably 0.02 to 0.05 wt % Sr, boron, TiB₂ and/or Na;
and the balance aluminum with up to 0.5 wt % inevitable impurities; wherein
the hard particles are selected from a group of carbides, nitrides, borides and/or oxides and the hard particles exhibit a size <20 μm and
the fibers are selected from a group of organic and/or inorganic fibers, and the fibers exhibit a length <50 μm and a diameter <3 m, in the form of nanotubes.

2. The sliding bearing material according to claim 1, wherein
the aluminum alloy contains lubricant.

3. The sliding bearing material according to claim 1, wherein
the fibers have a higher tensile strength and/or a higher modulus of elasticity and/or a lower fracture elongation in the longitudinal direction than the aluminum alloy matrix.

4. The sliding bearing material according to claim 1, wherein
an intermediate layer is provided between the steel substrate back and the aluminum alloy, said intermediate layer preferably consisting of an aluminum alloy of the 1xxx, 2xxx or 3xxx alloy series.

5. (canceled)

6. A sliding bearing, consisting, at least partially, of a sliding bearing material according to claim 1.

7. A method for producing a sliding bearing material according to claim 1, wherein
the aluminum alloy is applied to the steel substrate back by hot roll cladding or cold roll cladding.,

8. The method for producing a sliding bearing material according to claim 7, wherein
an aluminum foil consisting of an aluminum alloy of the 1xxx, 2xxx or 3xxx alloy series is first of all applied, to the steel substrate back before the roll cladding.

9. The method for producing a sliding bearing material according to claim 8, wherein
the aluminum alloy undergoes at least one homogenization and/or recrystallization heat treatment in the temperature range of 200° C. 600° C. with a holding time of 1-30 h before the roll cladding.

10. The method for producing a sliding bearing material according to claim 7, including:
transforming the alloy elements, hard particles and/or fibers of the aluminum alloy into a melting bath;
continuous casting the melt into a strand with substantially rectangular cross-section,
heat treatment of the strand,
rolling the strand
heat treatment of the rolled strand and
roll cladding the aluminum alloy onto a steel substrate back.

11. The sliding bearing of claim 1, wherein the group of carbides, borides and/or oxides is selected from the group TiC, MoC, AIN, c-BN, TiB₂, and/or Y₂O₃.

12. The sliding bearing of claim 1, wherein the group of carbides, borides and/or oxides is selected from the group SiC, Si₃N₄, ZrO₂, and or Al₂O₃.

13. The sliding bearing of claim 1, wherein the fibers are glass fibers and/or Al₂O₃.

14. The sliding bearing of claim 1, wherein the fibers are selected from the group of SiC; carbon and/or Al₂O₃ fibers.

15. The sliding bearing of claim 2 wherein the lubricant comprises h-BN and/or graphite.

16. The sliding hearing of claim 15 wherein the lubricant has a concentration of 0.01 to 10 wt %.

17. The method of claim 8, wherein the aluminum foil is roll cladded.
